(19) United States
(12) Patent Application Publication
(10) Pub. No.: US 2010/0284802 A1
(43) Pub. Date: Nov. 11, 2010

(54) INFLATABLE WIND TURBINE

(75) Inventors: Walter M. Presz, JR., Wilbraham, MA (US); Michael J. Werle, West Hartford, CT (US); Thomas J. Kennedy, III, Wilbraham, MA (US); William Scott Keeley, Charleston, RI (US)

Correspondence Address: FAY SHARPE LLP, 1228 Euclid Avenue, 5th Floor, The Halle Building, Cleveland, OH, 44115, US

(73) Assignee: FLODESIGN WIND TURBINE CORPORATION, Wilbraham, MA (US)

(21) Appl. No.: 12/793,385

(22) Filed: Jun. 3, 2010

Related U.S. Application Data
(63) Continuation-in-part of application No. 12/555,446, filed on Sep. 8, 2009.
Application No. 12/555,446 is a continuation-in-part of application No. 12/054,050, filed on Mar. 24, 2008.
(60) Provisional application No. 61/183,749, filed on Jun. 3, 2009.
(60) Provisional application No. 61/191,358, filed on Sep. 8, 2008.
(60) Provisional application No. 60/919,588, filed on Mar. 23, 2007.

(51) Int. Cl. F03D 1/04; F03D 11/00

(52) U.S. Cl. 415/182.1

(57) ABSTRACT

A wind turbine has an impeller surrounded by a shroud. The shroud is formed from inflatable components extending between two rigid structural members. When inflated, the shroud acts to increase the energy generated by the impeller. Under adverse wind conditions, the inflatable components can be deflated to reduce surface area and wind load on the turbine.

### BACKGROUND

This application claims priority to U.S. Provisional Patent Application Ser. No. 61/183,749, filed Jun. 3, 2009. This application is also a continuation-in-part application of U.S. patent application Ser. No. 12/555,446, filed Sep. 8, 2009, which claims priority from U.S. Provisional Patent Application Ser. No. 61/191,358, filed on Sep. 8, 2008. This application is also a continuation-in-part from U.S. patent application Ser. No. 12/054,050, filed Mar. 24, 2008, which claimed priority from U.S. Provisional Patent Application Ser. No. 60/919,588, filed Mar. 23, 2007. The disclosure of these applications is hereby fully incorporated by reference in their entirety.

The present disclosure relates to wind turbines having inflatable components.

Conventional wind turbines used for power generation generally have two to five open blades arranged like a propeller, the blades being mounted to a horizontal shaft attached to a gear box which drives a power generator. Such turbines are generally known as horizontal axis wind turbines, or HAWTs. Although HAWTs have achieved widespread usage, their efficiency is not optimized. In particular, they will not exceed the Betz limit of 59.3% efficiency in capturing the potential energy of the wind passing through it.

Conventional wind turbines have three blades and are oriented or pointed into the wind by computer controlled motors. These turbines typically require a supporting tower ranging from 60 to 90 meters in height. The blades generally rotate at a rotational speed of about 10 to 22 rpm. A gear box is commonly used to step up the speed to drive the generator, although some designs may directly drive an annular electric generator. Some turbines operate at a constant speed. However, more energy can be collected by using a variable speed turbine and a solid state power converter to interface the turbine with the generator.

Several problems are associated with HAWTs in both construction and operation. The tall towers and long blades are difficult to transport. Massive tower construction is required to support the heavy blades, gearbox, and generator. Very tall and expensive cranes and skilled operators are needed for installation. In operation, HAWTs require an additional yaw control mechanism to turn the blades toward the wind. HAWTs typically have a high angle of attack on their airfoils that do not lend themselves to variable changes in wind flow. HAWTs are difficult to operate in near ground, turbulent winds. Ice build-up on the nacelle and the blades can cause power reduction and safety issues. Tall HAWTs may affect airport radar. Their height also makes them obtrusively visible across large areas, disrupting the appearance of the landscape and sometimes creating local opposition. Finally, downwind variants suffer from fatigue and structural failure caused by turbulence.

It would be desirable to reduce the size of wind turbines and to reduce wind turbine surface area under an undesirable wind load.

### BRIEF DESCRIPTION

The present disclosure describes wind turbines of reduced mass and size. In particular, the wind turbines include a turbine shroud and/or ejector shroud having inflatable components. Such wind turbines are lighter. An inflated shroud would allow the turbine to change its aerodynamics/shape to accommodate changes in fluid flow. It would also allow for less substantial supports in the turbine body, and also allow the inflated portions to be deflated if needed due to adverse weather conditions. The inflated portions of the turbine do not actively rotate to aid in energy extraction or power production. The inflated portions may be covered by an exterior skin and/or an interior skin. The skins may add strength, water resistance, ultra violet (UV) stability, and other functionality.

A mixer/ejector wind turbine system (referenced herein as a “MEWT”) for generating power is disclosed that combines fluid dynamic ejector concepts, advanced flow mixing and control devices, and an adjustable power turbine. In some embodiments or versions, the MEWT is an axial flow turbine comprising, in order going downstream: an aerodynamically contoured turbine shroud having an inlet; a ring of stators within the shroud; an impeller having a ring of impeller blades “in line” with the stators; a mixer, associated with the turbine shroud, having a ring of mixing lobes extending downstream beyond the impeller blades; and an ejector comprising the ring of mixing lobes and a mixing shroud extending downstream beyond the mixing lobes. The turbine shroud, mixer and ejector are designed and arranged to draw the maximum amount of wind through the turbine and to minimize impact upon the environment (e.g., noise) and upon other power turbines in its wake (e.g., structural or productivity losses). Unlike existing wind turbines, the preferred MEWT contains a shroud with advanced flow mixing and control devices such as lobed or slotted mixers and/or one or more ejector pumps. The mixer/ejector pump presented is much different than used heretofore since in the disclosed wind turbine, the high energy air flows into the ejector inlets, and outwardly surrounds, pumps and mixes with the low energy air exiting the turbine shroud.

Also disclosed in other embodiments is a turbine comprising: a mixer shroud having an outlet and an inlet for receiving a primary fluid stream; and means for extracting energy from the primary fluid stream, the means for extracting energy being located within the turbine shroud; wherein the mixer shroud includes a set of high energy mixing lobes and a set of low energy mixing lobes; wherein each high energy mixing lobe forms an angle in the range of about of 5 to 65 degrees relative to the mixer shroud; and wherein each low energy mixing lobe forms an angle in the range of about 5 to 65 degrees relative to the mixer shroud or the turbine axis.

The high energy mixing lobe angle may be different from, greater than, less than, or equal to the low energy mixing lobe angle.

The turbine may further comprise an ejector shroud downstream from and coaxial with the mixer shroud, wherein a mixer shroud outlet extends into an ejector shroud inlet. The ejector shroud may itself have a ring of mixer lobes around its outlet.

The means for extracting energy may be an impeller or a rotor/stator assembly.

Disclosed in embodiments is a wind turbine comprising an impeller and a shroud located concentrically about the impeller. The shroud comprises a first rigid structural member, a second rigid structural member, and one or more inflatable members extending between the first rigid structural member and the second rigid structural member.

The first rigid structural member may comprise an inlet, one or more nozzles located on a trailing side for providing a gas to the one or more inflatable members, and a gas flowpath running from the inlet to the one or more nozzles. This allows a gas, such as air, to be passed through the first structural member into the inflatable member(s).

In some embodiments, the one or more inflatable members each comprise a first strut, a second strut, and circumferential spars. The first and second struts extend from the first rigid structural member and the second rigid structural member. A plurality of circumferential spars extends between the first strut and the second strut.

The second rigid structural member may have a circular crenellated shape. In such embodiments, the one or more inflatable members can include a set of airfoil inflatable members and a set of surface inflatable members.

The one or more inflatable members together may have an airfoil shape.

The one or more inflatable members can be formed from a textile material. The textile material can be selected from the group consisting of polyester, polyurethane, polyamide, polytrimethylene terephthalate, cellulose fibers, and mixtures thereof.

The shroud may comprise an exterior skin surrounding the one or more inflatable members. The exterior skin may comprise a polyurethane or a fluoropolymer. The fluoropolymer can be selected from the group consisting of polyvinyl fluoride and polyvinylidene fluoride. The shroud could also comprise an interior skin, which can also be a polyurethane or a fluoropolymer.

Disclosed in other embodiments is a wind turbine comprising an impeller and a turbine shroud surrounding the impeller. The turbine shroud comprises a first rigid structural member, a second rigid structural member having a circular crenellated shape, and one or more inflatable members extending between the first rigid structural member and the second rigid structural member.

Disclosed in still other embodiments is a wind turbine comprising an impeller, a turbine shroud surrounding the impeller and having an outlet end; and an ejector shroud surrounding the turbine shroud. The inlet end of the ejector shroud surrounds an outlet end of the turbine shroud. The ejector shroud comprises a first rigid structural member, a second rigid structural member, and one or more inflatable members extending between the first rigid structural member and the second structural member.

The one or more inflatable members together may have an airfoil shape.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is an exploded view of a first exemplary embodiment or version of a MEWT of the present disclosure.

FIG. 2 is a front perspective view of FIG. 1 attached to a support tower.

FIG. 3 is a front perspective view of a second exemplary embodiment of a MEWT, shown with a shrouded three bladed impeller.

FIG. 4 is a rear view of the MEWT of FIG. 3.

FIG. 5 is a cross-sectional view taken along line 5-5 of FIG. 4.

FIG. 6 is a perspective view of another exemplary embodiment of a wind turbine of the present disclosure having a pair of wing-tabs for wind alignment.

FIG. 7 is a front perspective view of another exemplary embodiment of a MEWT of the present disclosure. Here, both the turbine shroud and the ejector shroud have mixing lobes on their trailing edges.

FIG. 8 is a rear perspective view of the MEWT of FIG. 7.

FIG. 9 is a front perspective view of another exemplary embodiment of a MEWT according to the present disclosure.

FIG. 10 is a side cross-sectional view of the MEWT of FIG. 9 taken through the turbine axis.

FIG. 11 is a smaller view of FIG. 10.

FIG. 11A and FIG. 11B are magnified views of the mixing lobes of the MEWT of FIG. 9.

FIG. 12 is a perspective view of an exemplary embodiment of a wind turbine having a shroud formed from inflatable components.

FIG. 13 is a perspective view showing an exemplary embodiment of a inflatable component used to form a shroud.

FIG. 14 is a side view of a structural member through which the inflatable components can be inflated.

FIG. 15 is a rear view of the structural member of FIG. 14.

FIG. 16 is a perspective view showing a plurality of inflatable components assembled together to form a shroud.

FIG. 17 is a perspective view showing a plurality of inflatable components attached to structural members and in a deflated condition.

FIG. 18 is a perspective view of a wind turbine shroud made from inflatable components and covered by an exterior skin.

FIG. 19 is a perspective view of a wind turbine shroud formed by a second exemplary embodiment of an inflatable component.

FIG. 20 is a perspective view of an exemplary wind turbine illustrating one method of inflating the inflatable components.

FIG. 21 is a perspective view illustrating the use of inflatable components to form a wind turbine shroud with mixing lobes.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate the relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”
A Mixer-Ejector Power System (MEPS) provides a unique and improved means of generating power from wind currents. A MEPS includes:
a primary shroud containing a turbine or bladed impeller, similar to a propeller, which extracts power from the primary stream; and

a single or multiple-stage mixer-ejector to ingest flow with each such mixer/ejector stage including a mixing duct for both bringing in secondary flow and providing flow mixing-length for the ejector stage. The inlet contours of the mixing duct or shroud are designed to minimize flow losses while providing the pressure forces necessary for good ejector performance.

The resulting mixer/ejectors enhance the operational characteristics of the power system by: (a) increasing the amount of flow through the system, (b) reducing the exit or back pressure on the turbine blades, and (c) reducing the noise propagating from the system.

The MEPS may include:
camber to the duct profiles to enhance the amount of flow into and through the system;
acoustical treatment in the primary and mixing ducts for noise abatement flow guide vanes in the primary duct for control of flow swirl and/or mixer-lobes tailored to diminish flow swirl effects;
turbine-like blade aerodynamics designs based on the new theoretical power limits to develop families of short, structurally robust configurations which may have multiple and/or counter-rotating rows of blades;
exit diffusers or nozzles on the mixing duct to further improve performance of the overall system;
inlet and outlet areas that are non-circular in cross section to accommodate installation limitations;
a swivel joint on its lower outer surface for mounting on a vertical stand/pylon allowing for turning the system into the wind;
vertical aerodynamic stabilizer vanes mounted on the exterior of the ducts with tabs or vanes to keep the system pointed into the wind; or
mixer lobes on a single stage of a multi-stage ejector system.

Referring to the drawings in detail, the figures illustrate alternate embodiments of Applicants' axial flow Wind Turbine with Mixers and Ejectors (“MEWT”).

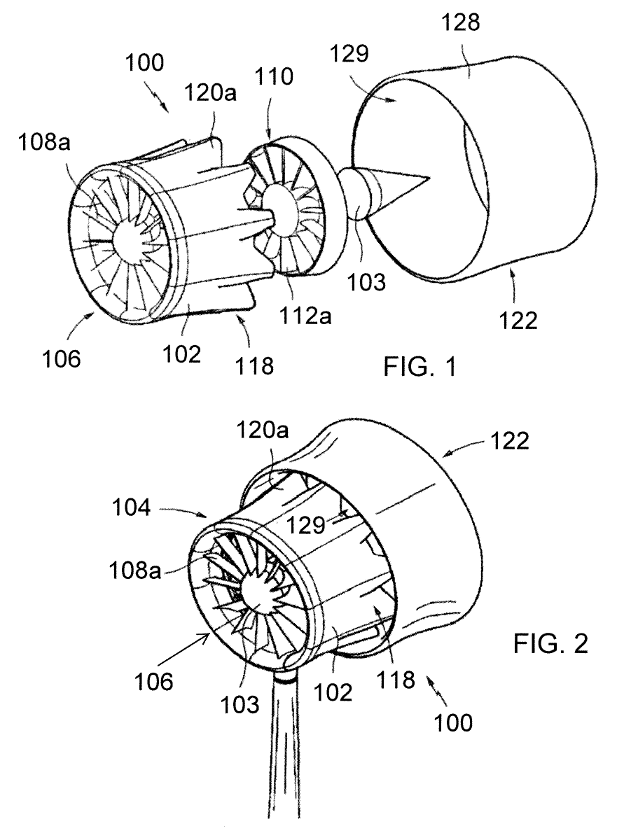

Referring to FIG. 1 and FIG. 2, the MEWT 100 is an axial flow turbine with:
a) an aerodynamically contoured turbine shroud 102;
b) an aerodynamically contoured center body 103 within and attached to the turbine shroud 102;
c) a turbine stage 104, surrounding the center body 103, comprising a stator ring 106 having stator vanes 108a and a rotor 110 having rotor blades 112a. Rotor 110 is downstream and “in-line” with the stator vanes, i.e., the leading edges of the impeller blades are substantially aligned with trailing edges of the stator vanes, in which:
   (i) the stator vanes 108a are mounted on the center body 103;
   (ii) the rotor blades 112a are attached and held together by inner and outer rings or hoops mounted on the center body 103;
d) a mixer indicated generally at 118 having a ring of mixer lobes 120a on a terminus region (i.e., end portion) of the turbine shroud 102, wherein the mixer lobes 120a extend downstream beyond the rotor blades 112a; and,
e) an ejector indicated generally at 122 comprising an ejector shroud 128, surrounding the ring of mixer lobes 120a on the turbine shroud, wherein the mixer lobes (e.g., 120a) extend downstream and into an inlet 129 of the ejector shroud 128.

The center body 103 of MEWT 100, as shown in FIG. 2, is desirably connected to the turbine shroud 102 through the stator ring 106, or other means. This construction serves to eliminate the damaging, annoying and long distance propagating low-frequency sound produced by traditional wind turbines as the wake from the turbine blades strike the support tower. The aerodynamic profiles of the turbine shroud 102 and ejector shroud 128 are aerodynamically cambered to increase flow through the turbine rotor.

Applicants have calculated, for optimum efficiency, the area ratio of the ejector pump 122, as defined by the ejector shroud 128 exit area over the turbine shroud 102 exit area, will be in the range of 1.5-3.0. The number of mixer lobes 120a would be between 6 and 14. Each lobe will have inner and outer trailing edge angles between 5 and 65 degrees. These angles are measured from a tangent line that is drawn at the exit of the mixing lobe down to a line that is parallel to the center axis of the turbine, as will be explained further herein. The primary lobe exit location will be at, or near, the entrance location or inlet 129 of the ejector shroud 128. The height-to-width ratio of the lobe channels will be between 0.5 and 4.5. The mixer penetration will be between 50% and 80%. The center body 103 plug trailing edge angles will be thirty degrees or less. The length to diameter (L/D) of the overall MEWT 100 will be between 0.5 and 1.25.

First-principles-based theoretical analysis of the preferred MEWT 100, performed by Applicants, indicate the MEWT can produce three or more times the power of its un-shrouded counterparts for the same frontal area; and, the MEWT 100 can increase the productivity of wind farms by a factor of two or more. Based on this theoretical analysis, it is believed the MEWT embodiment 100 will generate three times the existing power of the same size conventional open blade wind turbine.

A satisfactory embodiment 100 of the MEWT comprises: an axial flow turbine (e.g., stator vanes and impeller blades) surrounded by an aerodynamically contoured turbine shroud 102 incorporating mixing devices in its terminus region (i.e., end portion); and a separate ejector shroud 128 overlapping, but aft, of turbine shroud 102, which itself may incorporate mixer lobes in its terminus region. The ring 118 of mixer lobes 120a combined with the ejector shroud 128 can be thought of as a mixer/ejector pump. This mixer/ejector pump provides the means for consistently exceeding the Betz limit for operational efficiency of the wind turbine. The stator vanes' exit-angle incidence may be mechanically varied in situ (i.e., the vanes are pivoted) to accommodate variations in the fluid stream velocity so as to assure minimum residual swirl in the flow exiting the rotor.

Described differently, the MEWT 100 comprises a turbine stage 104 with a stator ring 106 and a rotor 110 mounted on center body 103, surrounded by turbine shroud 102 with embedded mixer lobes 120a having trailing edges inserted slightly in the entrance plane of ejector shroud 128. The turbine stage 104 and ejector shroud 128 are structurally connected to the turbine shroud 102, which is the principal load carrying member.

These figures depict a rotor/stator assembly for generating power. The term “impeller” is used herein to refer generally to any assembly in which blades are attached to a shaft and able to rotate, allowing for the generation of power or energy from wind rotating the blades. Exemplary impellers include a propeller or a rotor/stator assembly. Any type of impeller may be enclosed within the turbine shroud 102 in the wind turbine of the present disclosure.

In some embodiments, the length of the turbine shroud 102 is equal or less than the turbine shroud's outer maximum diameter. Also, the length of the ejector shroud 128 is equal or less than the ejector shroud's outer maximum diameter. The exterior surface of the center body 103 is aerodynamically contoured to minimize the effects of flow separation downstream of the MEWT 100. It may be configured to be longer or shorter than the turbine shroud 102 or the ejector shroud 128, or their combined lengths.

The turbine shroud's entrance area and exit area will be equal to or greater than that of the annulus occupied by the turbine stage 104, but need not be circular in shape so as to allow better control of the flow source and impact of its wake. The internal flow path cross-sectional area formed by the annulus between the center body 103 and the interior surface of the turbine shroud 102 is aerodynamically shaped to have a minimum area at the plane of the turbine and to otherwise vary smoothly from their respective entrance planes to their exit planes. The turbine and ejector shrouds' external surfaces are aerodynamically shaped to assist guiding the flow into the turbine shroud inlet, eliminating flow separation from their surfaces, and delivering smooth flow into the ejector entrance 129. The ejector 128 entrance area, which may alternatively be noncircular in shape, is greater than the mixer 118 exit plane area; and the ejector's exit area may also be noncircular in shape if desired.

Optional features of the preferred embodiment 100 can include: a power take-off, in the form of a wheel-like structure, which is mechanically linked at an outer rim of the impeller to a power generator; a vertical support shaft with a rotatable coupling for rotatably supporting the MEWT, the shaft being located forward of the center-of-pressure location on the MEWT for self-aligning the MEWT; and a self-moving vertical stabilizer fin or “wing-tab” affixed to upper and lower surfaces of the ejector shroud to stabilize alignment directions with different wind streams.

The MEWT 100, when used near residences can have sound absorbing material affixed to the inner surface of its shrouds 102, 128 to absorb and thus eliminate the relatively high frequency sound waves produced by the interaction of the stator 106 wakes with the rotor 110. The MEWT 100 can also contain blade containment structures for added safety. The MEWT should be considered to be a horizontal axis wind turbine as well.

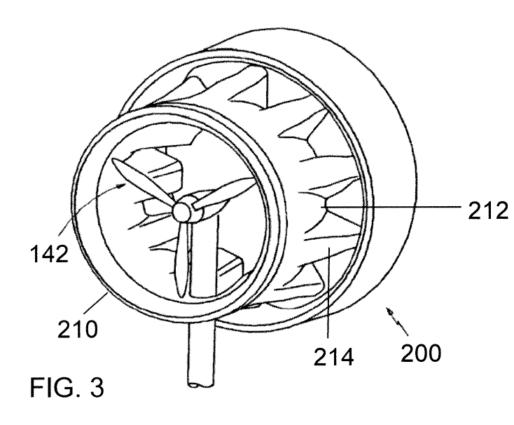

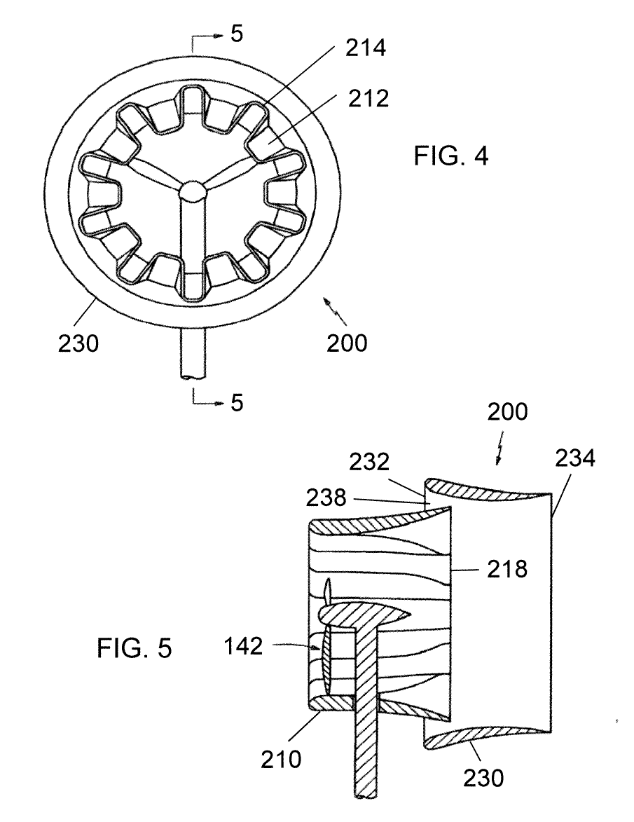

FIGS. 3-5 show a second exemplary embodiment of a shrouded wind turbine 200. The turbine 200 uses a propeller-type impeller 142 instead of the rotor/stator assembly as in FIG. 1 and FIG. 2. In addition, the mixing lobes can be more clearly seen in this embodiment. The turbine shroud 210 has two different sets of mixing lobes. Referring to FIG. 3 and FIG. 4, the turbine shroud 210 has a set of high energy mixing lobes 212 that extend inwards toward the central axis of the turbine. In this embodiment, the turbine shroud is shown as having 10 high energy mixing lobes. The turbine shroud also has a set of low energy mixing lobes 214 that extend outwards away from the central axis. Again, the turbine shroud 210 is shown with 10 low energy mixing lobes. The high energy mixing lobes alternate with the low energy mixing lobes around the trailing edge of the turbine shroud 210. From the rear, as seen in FIG. 4, the trailing edge of the turbine shroud may be considered as having a circular crenellated shape. The term “crenellated” or “castellated” refers to this general up-and-down or in-and-out shape of the trailing edge.

As seen in FIG. 5, the entrance area 232 of the ejector shroud 230 is larger than the exit area 234 of the ejector shroud. It will be understood that the entrance area refers to the entire mouth of the ejector shroud and not the annular area of the ejector shroud between the ejector shroud 230 and the turbine shroud 210. However, as seen further herein, the entrance area of the ejector shroud may also be smaller than the exit area 234 of the ejector shroud. As expected, the entrance area 232 of the ejector shroud 230 is larger than the exit area 218 of the turbine shroud 210, in order to accommodate the mixing lobes and to create an annular area 238 between the turbine shroud and the ejector shroud through which high energy air can enter the ejector.

The mixer-ejector design concepts described herein can significantly enhance fluid dynamic performance. These mixer-ejector systems provide numerous advantages over conventional systems, such as: shorter ejector lengths; increased mass flow into and through the system; lower sensitivity to inlet flow blockage and/or misalignment with the principal flow direction; reduced aerodynamic noise; added thrust; and increased suction pressure at the primary exit.

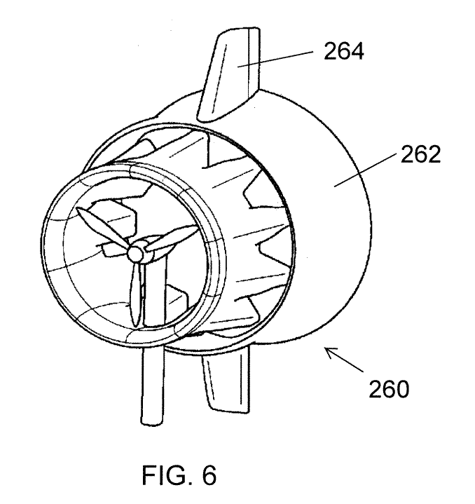

As shown in FIG. 6, another exemplary embodiment of a wind turbine 260 may have an ejector shroud 262 that has internal ribs shaped to provide wing-tabs or fins 264. The wing-tabs or fins 264 are oriented to facilitate alignment of the wind turbine 260 with the incoming wind flow to improve energy or power production.

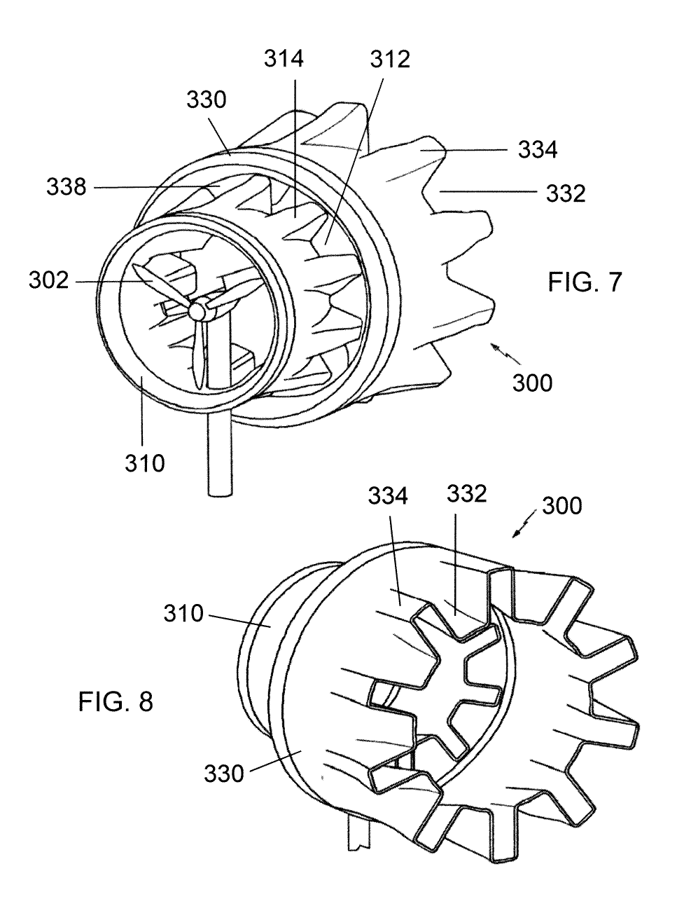

FIG. 7 and FIG. 8 illustrate another exemplary embodiment of a MEWT. The turbine 400 again uses a propeller-type impeller 302. The turbine shroud 310 has two different sets of mixing lobes. A set of high energy mixing lobes 312 extend inwards toward the central axis of the turbine. A set of low energy mixing lobes 314 extend outwards away from the central axis. In addition, the ejector shroud 330 is provided with mixing lobes on a trailing edge thereof. Again, two different sets of mixing lobes are present. A set of high energy mixing lobes 332 extend inwards toward the central axis of the turbine. A set of low energy mixing lobes 334 extend outwards away from the central axis. As seen in FIG. 8, the ejector shroud is shown here with 10 high energy mixing lobes and 10 low energy mixing lobes. The high energy mixing lobes alternate with the low energy mixing lobes around the trailing edge of the turbine shroud 330. Again, the trailing edge of the ejector shroud may be considered as having a circular crenellated shape.

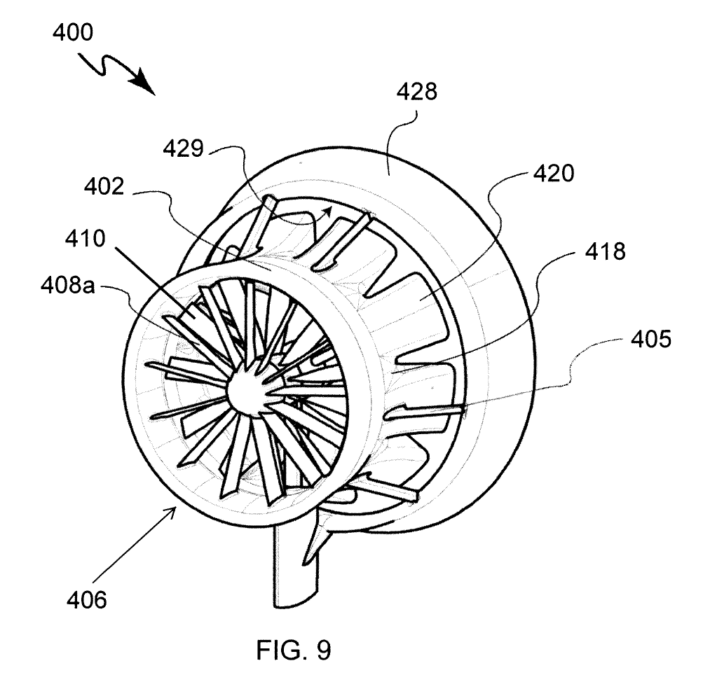

FIGS. 9-11 illustrate another exemplary embodiment of a MEWT. The MEWT 400 in FIG. 9 has a stator 408a and rotor 410 configuration for power extraction. A turbine shroud 402 surrounds the rotor 410 and is supported by or connected to the blades or spokes of the stator 408a. The turbine shroud 402 has the cross-sectional shape of an airfoil with the suction side (i.e. low pressure side) on the interior of the shroud. An ejector shroud 428 is coaxial with the turbine shroud 402 and is supported by connector members 405 extending between the two shrouds. An annular area is thus formed between the two shrouds. The rear or downstream end of the turbine shroud 402 is shaped to form two different sets of mixing lobes 418, 420. High energy mixing lobes 418 extend inwardly towards the central axis of the mixer shroud 402; and low energy mixing lobes 420 extend outwardly away from the central axis.

Free stream air indicated generally by arrow 406 passing through the stator 408a has its energy extracted by the rotor 410. High energy air indicated by arrow 429 bypasses the shroud 402 and stator 408a and flows over the turbine shroud 402 and directed inwardly by the high energy mixing lobes 418. The low energy mixing lobes 420 cause the low energy air exiting downstream from the rotor 410 to be mixed with the high energy air 429.

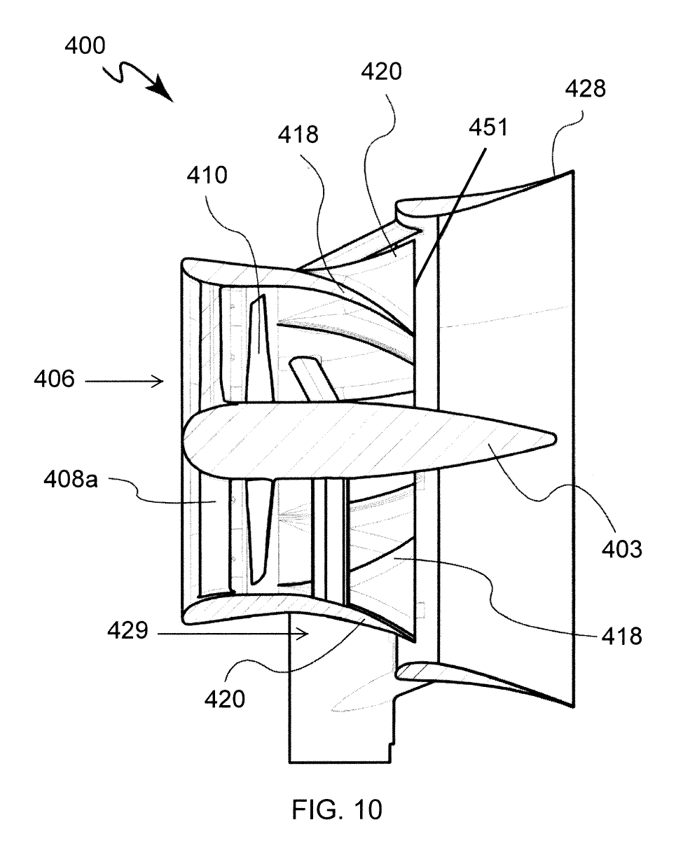

Referring to FIG. 10, the center nacelle 403 and the trailing edges of the low energy mixing lobes 420 and the trailing edge of the high energy mixing lobes 418 are shown in the axial cross-sectional view of the turbine of FIG. 9. The ejector shroud 428 is used to direct inwardly or draw in the high energy air 429. Optionally, nacelle 403 may be formed with a central axial passage therethrough to reduce the mass of the nacelle and to provide additional high energy turbine bypass flow.

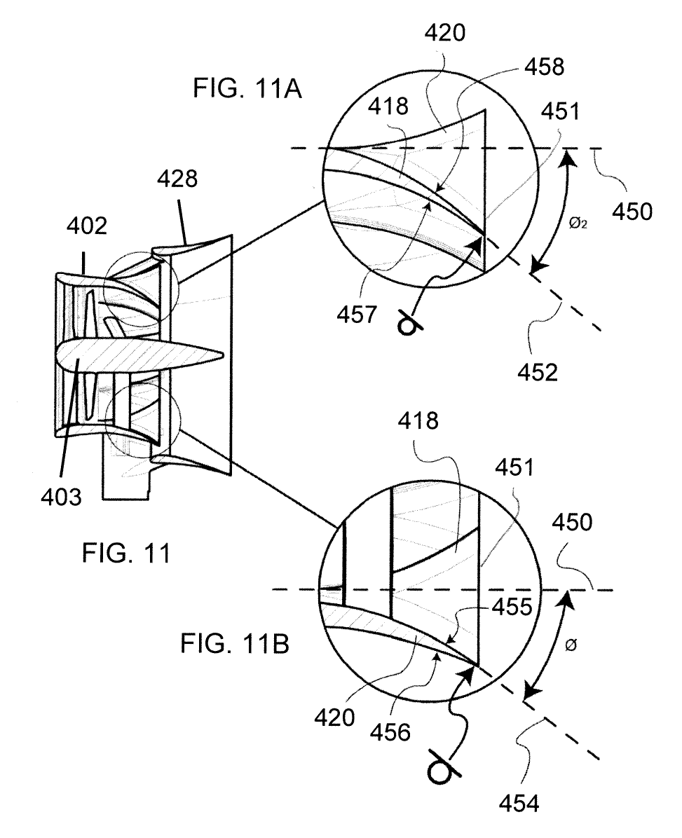

In FIG. 11A, a tangent line 452 is drawn along the interior trailing edge indicated generally at 457 of the high energy mixing lobe 418. A rear plane 451 of the turbine shroud 402 is present. A line 450 is formed normal to the rear plane 451 and tangent to the point where a low energy mixing lobe 420 and a high energy mixing lobe 418 meet. An angle Ø₂ is formed by the intersection of tangent line 452 and line 450. This angle Ø₂ is between 5 and 65 degrees. Put another way, a high energy mixing lobe 418 forms an angle Ø₂ between 5 and 65 degrees relative to the turbine shroud 402.

In FIG. 11B, a tangent line 454 is drawn along the interior trailing edge indicated generally at 455 of the low energy mixing lobe 420. An angle Ø is formed by the intersection of tangent line 454 and line 450. This angle Ø is between 5 and 65 degrees. Put another way, a low energy mixing lobe 420 forms an angle Ø between 5 and 65 degrees relative to the turbine shroud 402.

Generally, the wind turbine of the present disclosure comprises a shroud which is formed from inflatable components. This provides a wind turbine which has a lower mass compared to a HAWT.

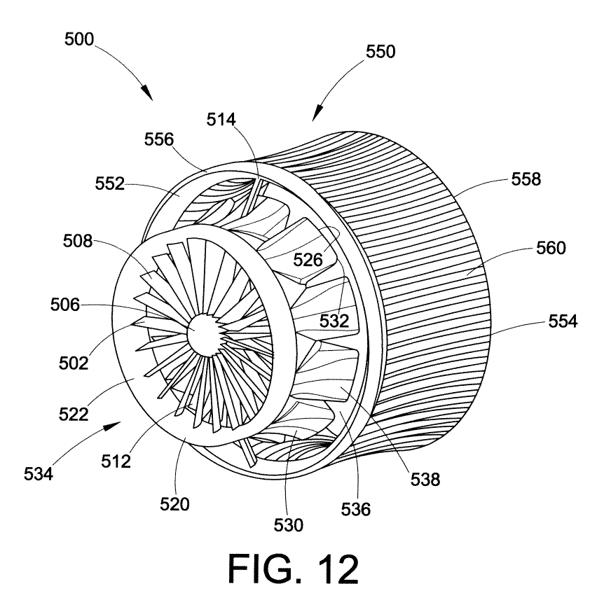

Referring now to FIG. 12, the turbine 500 comprises an impeller 502 surrounded by a turbine shroud 520. The impeller 502 is shown here as a rotor/stator assembly. The stator 504 comprises a center body 506 and a plurality of stationary stator vanes 508 extending radially from the center body 506. The stator vanes 508 bend the air before the air reaches the rotor blades 512.

The turbine shroud 520 has a leading edge 522 and a trailing edge 526. The leading edge 522 defines an intake end 534 of the turbine shroud, while the trailing edge 526 defines an exhaust end 532 of the turbine shroud. The leading edge 522 is annular and acts as a funnel to channel air through the impeller 502. The shroud is approximately cylindrical and has an airfoil shape, with the airfoil configured to generate relatively lower pressure within the turbine shroud (i.e. the interior of the shroud) and relatively higher pressure outside the turbine shroud (i.e. the exterior of the shroud). A plurality of mixing lobes 530 are generally uniformly distributed about the circumference of the exhaust end 532, or in other words along the trailing edge 526. The mixing lobes 530 may be divided into a set of high-energy mixing lobes 536 and a set of low-energy mixing lobes 538. The mixer lobes 530 generally cause the exhaust end 532 of the turbine shroud 520, where air exits, to have a circular crenellated shape about its circumference.

The ejector shroud 550 has a larger diameter than the turbine shroud 520. The trailing edge 526 of the turbine shroud 520 fits within the inlet end 552 of the ejector shroud 550. Put another way, the inlet end 552 of the ejector shroud 550 surrounds the exhaust end 532 of the turbine shroud 520. The turbine shroud 520 and ejector shroud 550 are sized so that air can flow between them. Phrased another way, the ejector shroud 550 is concentrically disposed about the turbine shroud 520 and is downstream of the turbine shroud 520. The impeller 502, turbine shroud 520, and ejector shroud 550 all share a common axis, i.e. are coaxial to each other. Support members 514 connect the turbine shroud 520 and the ejector shroud 550 together.

The inlet end 552 of the ejector shroud 550 is defined by a first rigid structural member 556. The exhaust end 554 is defined by a second rigid structural member 558. One or more inflatable members 560 extend between the first rigid structural member 556 and the second rigid structural member 558. In FIG. 12, they are inflated. The inflatable members 560 may also be fully or partially deflated to reduce the amount of surface area exposed to off-axis wind. The inflatable members 560 together provide an airfoil shape to the ejector shroud 550. The rigid members 556, 558 are considered rigid relative to the inflatable member 560, and in practice may be made from materials which might be considered flexible by other standards.

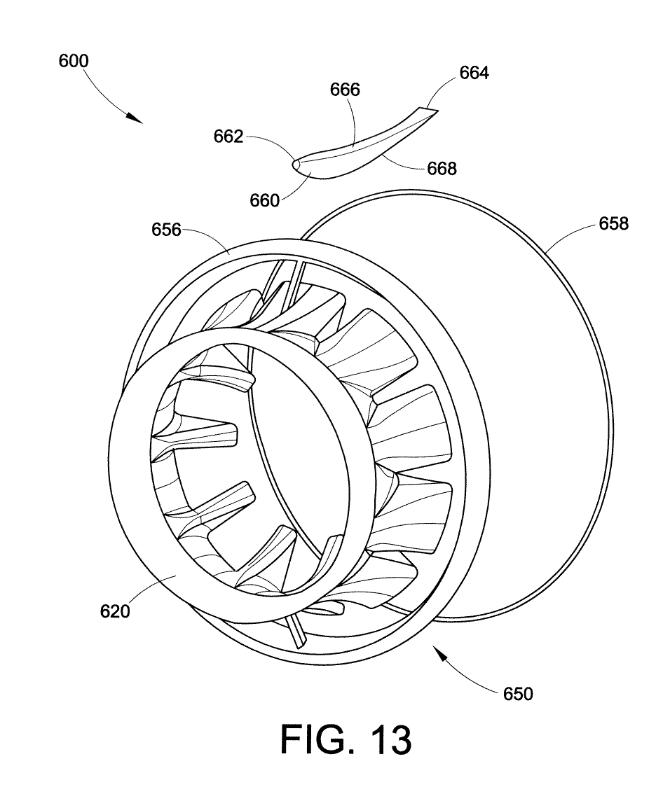

FIG. 13 shows a wind turbine 600 without an impeller, and before inflatable members 660 are added to the ejector shroud 650. The turbine shroud 620, having mixing lobes, is shown with ejector shroud 650. As shown here, both the first rigid structural member 656 and the second rigid structural member 658 have an annular shape. An inflatable member 660 is also shown. The front of the inflatable member 660 has a coupling 662 through which air or other gases can be pumped into the inflatable member, as will be discussed later. The rear 664 of the inflatable member has the shape of a flat line. The inflatable member also has a relatively flat top surface 662 and a curved bottom surface 664.

Generally, the inflatable member 660 can be connected to the second rigid structural member 658 using means that permit the member to be inflated. For example, adhesives or other fasteners can be used. The inflatable member 660 is connected to the first rigid structural member 656 using the coupling 662, so that air or other suitable gases can be pumped into the inflatable member.

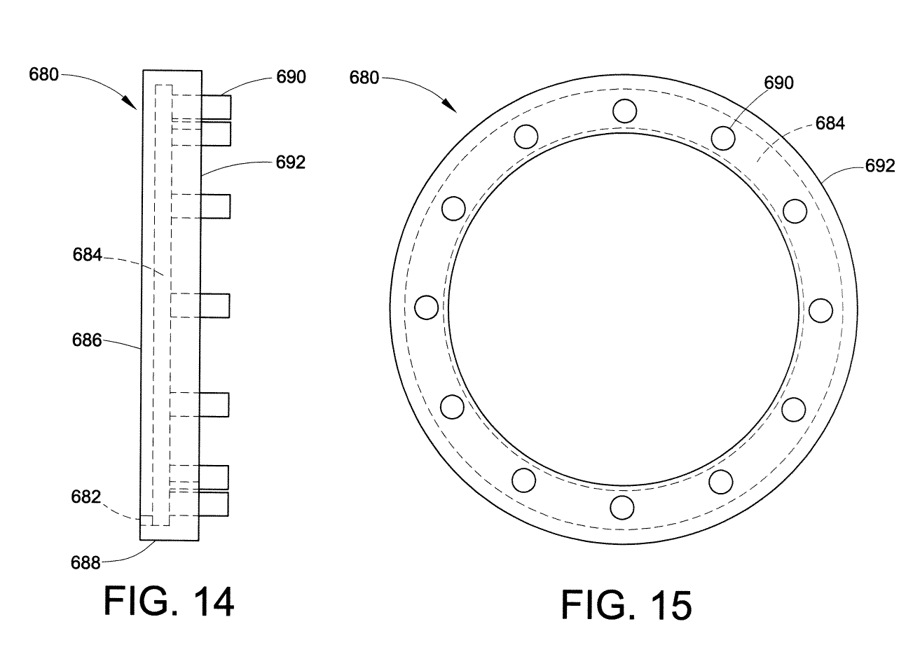

FIG. 14 and FIG. 15 are a side view and a rear view, respectively, of an exemplary first rigid structural member 680 which can be used to inflate the inflatable members. Here, the exterior of the first rigid structural member 680 includes an inlet 682 which provides access to a gas flowpath 684 inside the first structural member. The inlet 682 can be located on a front side 686 or bottom side 688 of the first structural member 680. The gas flowpath runs around the entirety of the first structural member.

One or more nozzles 690 are located on a trailing side 692 of the first structural member. As depicted here, the nozzles extend from the trailing side; however, embodiments are also contemplated where the trailing side includes cavities in which the nozzles are located. Using this structure, air or another gas is provided through the inlet 682 and subsequently runs through the gas flowpath 684 out the nozzles 690 into the inflatable members. Valves (not shown) can be used to independently control the amount of gas released by or added to each inflatable member, as well as to simply retain the gas within the inflatable member.

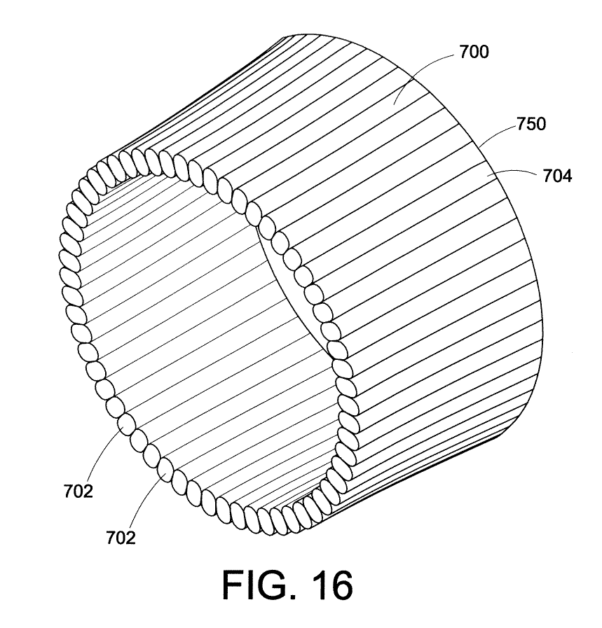

FIG. 16 shows an embodiment of an inflatable member 700 that can be used to form an airfoil shaped ejector shroud 750. The front of the inflatable member includes a plurality of couplings 702 which can be connected to the nozzles of a structural member. This can be useful for evenly distributing gas as the inflatable member is inflated. The inflatable member tapers in an airfoil shape from the couplings 702 to the rear 704, which has a circular shape for attaching to the second structural member.

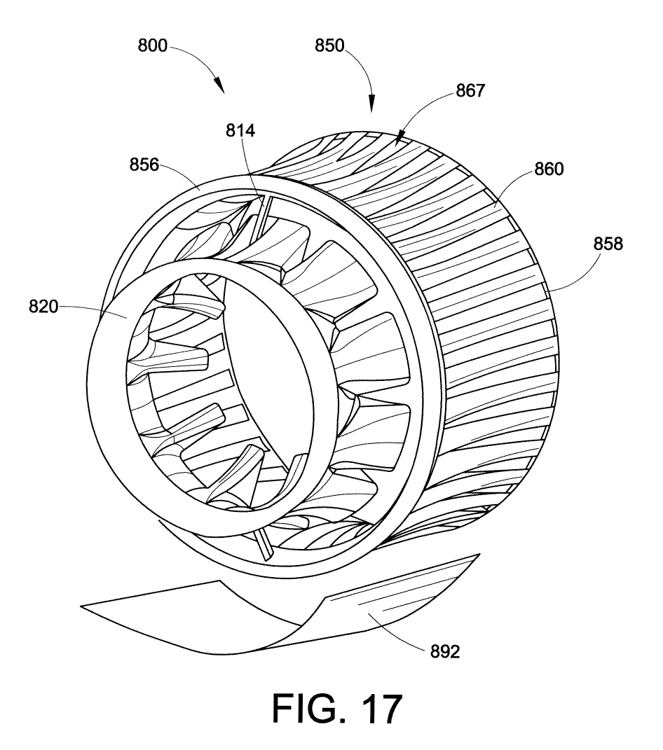

FIG. 17 shows a wind turbine 800 having a turbine shroud 820 and an ejector shroud 850, which are joined together with support members 814. On the ejector shroud, a plurality of inflatable members 860 extends between the first rigid structural member 856 and the second rigid structural member 858. The inflatable members are partially deflated, resulting in gaps 867 extending axially between adjacent inflatable members 860. The gaps are useful in high wind situations when the wind is coming from an off-axis direction. In those cases, the gaps reduce the amount of surface area exposed to the wind by the wind turbine. An exterior panel 892 is also shown, which can be added to the ejector shroud to form an exterior skin.

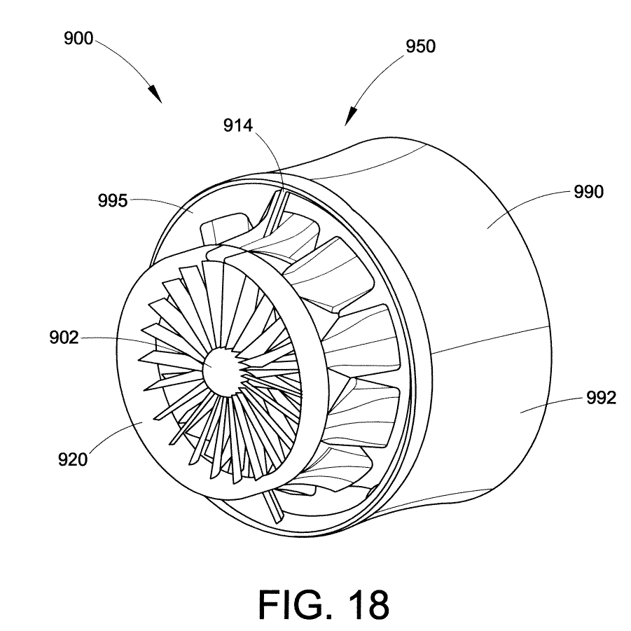

FIG. 18 shows a wind turbine 900. The impeller 902 is shown here, along with turbine shroud 920 and support members 914 connecting the turbine shroud to the ejector shroud 950. The ejector shroud 950 includes an interior skin 995 and an exterior skin 990. The skins cover the inflatable members. The ejector shroud exterior skin 990 is formed from a plurality of panels 992. The skins are designed to fragment or otherwise be removed in high wind situations, which exposes the gaps formed between deflated inflatable members as seen in FIG. 17. The exterior and interior skins may be made from the same or different materials.

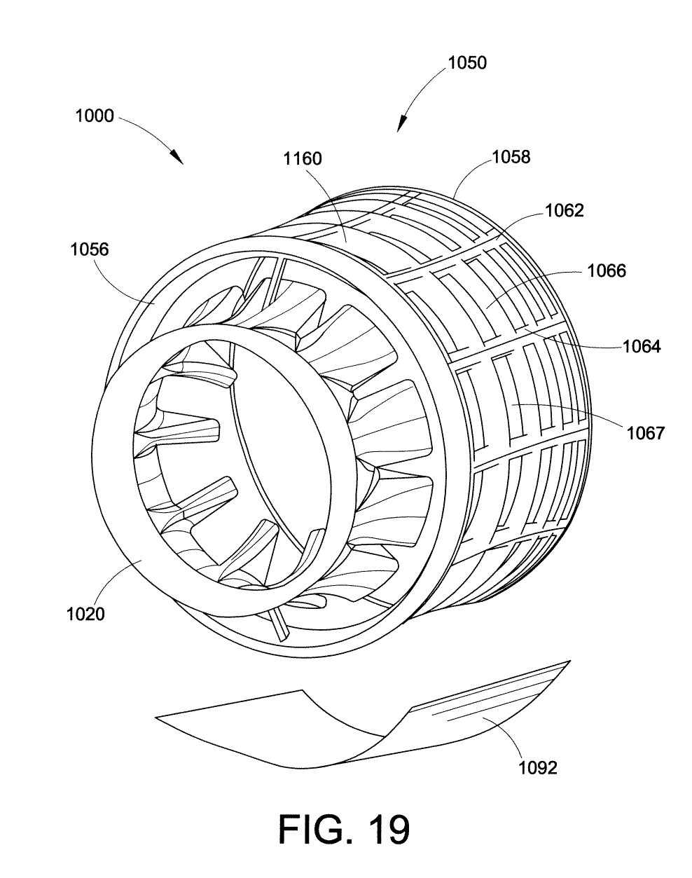

FIG. 19 depicts another embodiment of a wind turbine 1000 similar to the embodiment of FIG. 17. A turbine shroud 1020 and ejector shroud 1050 are shown. The ejector shroud includes a first rigid structural member 1056, a second rigid structural member 1058, and inflatable members 1060. Here, each inflatable member comprises a first strut 1062 and a second strut 1064, which extend from the first structural member 1056 to the second structural member 1058. A plurality of circumferential spars 1066 extend between the first strut 1062 and the second strut 1064. The resulting inflatable member has a “ladder” form. An exterior panel 1092 is also shown for covering the inflatable member. In comparison to the inflatable member shown in FIG. 17, this embodiment of an inflatable member does not need to be partially deflated in order for gaps 1067 to be present; such gaps are formed between the struts and the circumferential spars. Again, the inflatable member 1060 has an airfoil shape.

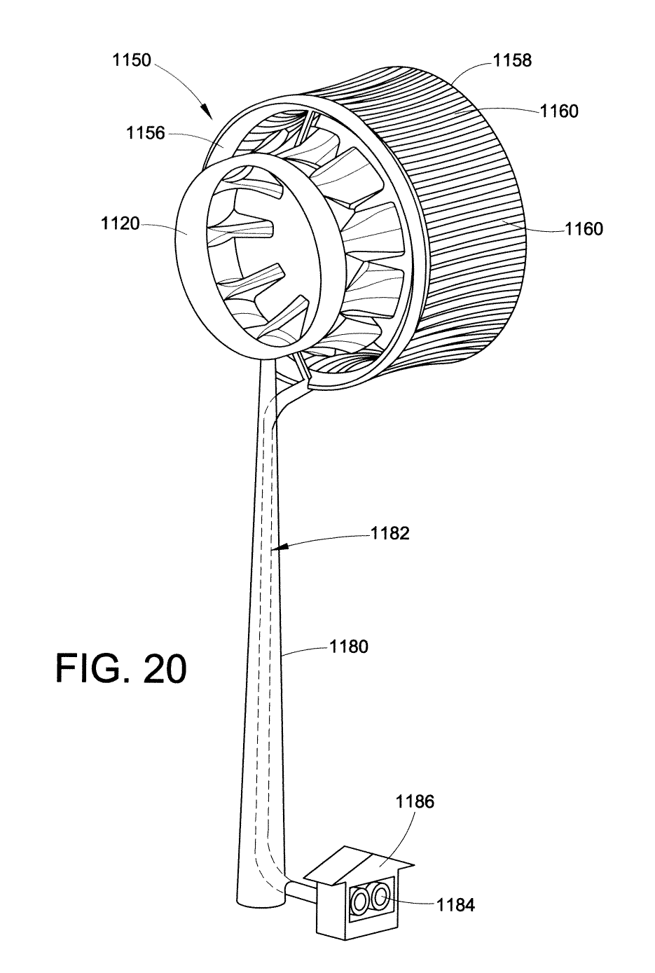

FIG. 20 illustrates one way in which the inflatable components can be used in a wind turbine. Here, a turbine shroud 1120 and ejector shroud 1150 are elevated above the ground by a tower 1180. The ejector shroud 1150 includes a first rigid structural member 1156 and inflatable members 1160. Air compressors or fans 1184 are housed in a weather-tight housing 1186 at the base of the tower. The tower 1180 contains a conduit 1182 through which compressed gases can be supplied through the first structural member 1156 to the inflatable members 1160. In addition, it is contemplated that hot gases can be pumped into the inflatable members, particularly in cold conditions, to melt or loosen ice and snow.

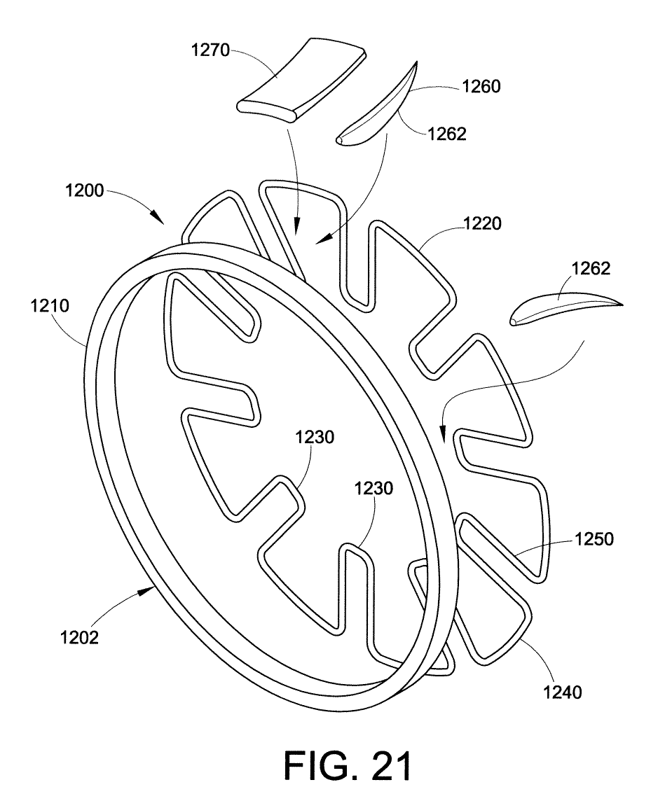

It is contemplated that the turbine shroud as well as the ejector shroud may each include mixing lobes on their trailing edge, and FIG. 21 illustrates how inflatable members can be used to form such a structure. As shown here, the shroud 1200 comprises a first rigid structural member 1210 and a second rigid structural member 1220. The first structural member 1210 forms a leading edge 1202 of the shroud.

The second rigid structural member 1220 has a circular crenellated or castellated shape. The second rigid structural member can be considered as being formed from several inner circumferentially spaced arcuate portions 1230 which each have the same radius of curvature. Those inner arcuate portions are preferably evenly spaced apart from each other. In those spaces between portions are several outer arcuate portions 1240, which each have the same radius of curvature. The radius of curvature for the inner arcuate portions 1230 is different from the radius of curvature for the outer arcuate portions 1240, but the inner arcuate portions and outer arcuate portions should share generally the same center. The inner portions 1230 and the outer arcuate portions 1240 are then connected to each other by radially extending portions 1250. This results in a circular crenellated shape. The term “crenellated” or “castellated” are not used herein as requiring the inner arcuate portions, outer arcuate portions, and radially extending portions to be straight lines, but rather to refer to the general up-and-down or in-and-out shape of the second rigid structural member. As will be explained further herein, this structure forms two sets of mixing lobes, high energy mixing lobes and low energy mixing lobes. It should be noted that the crenellated shape may be only part of the second rigid structural member 1220, and that the second rigid structural member could be shaped differently further upstream of the crenellated shape.

Two or three sets of inflatable members are used to form the mixing lobes. Airfoil inflatable members 1260 have a curved shape, and are used to define the mixing lobes themselves. Generally, one set of airfoil inflatable members 1262 is used to connect the first structural member 1210 to the corners of the outer arcuate portions 1240 of the second structural member 1220. Another set of airfoil inflatable members 1264 is used to connect the first structural member 1210 to the corners of the inner arcuate portions 1230 of the second structural member. There may be one or two sets of airfoil inflatable members, depending on the curvature desired for the mixing lobes. A set of surface inflatable members 1270 is also used, with a surface inflatable member being placed between each airfoil inflatable member. The surface inflatable members may also have a curved shape. Generally speaking, the airfoil members can be considered as defining edges of the mixing lobes, while the surface members form the surfaces of the mixing lobes.

The inflatable members described here may include several internal chambers within for controlling the amount of lift or the degree of inflation. These internal chambers may be arranged around the circumference of the inflatable member, or from one end of the inflatable member to the other end, as desired.

The thin film material used for forming the inflatable member, the exterior skin, and/or the interior skin of the shroud may be generally formed of any polymeric or fabric material. Exemplary materials include polyurethane, polyfluoropolymers, and multi-layer films of similar composition. Stretchable fabrics, such as spandex-type fabrics, may also be employed. The inflatable members may comprise a plurality of closed fabric forms. Fibers and/or additional layers may be included to ensure that the inflatable members maintain the desired shape when inflated.

Polyurethane films are tough and have good weatherability. The polyester-type polyurethane films tend to be more sensitive to hydrophilic degradation than polyether-type polyurethane films. Aliphatic versions of these polyurethane films are generally ultraviolet resistant as well.

Exemplary polyfluoropolymers include polyvinyldidene fluoride (PVDF) and polyvinyl fluoride (PVF). Commercial versions are available as KYNAR and TEDLAR. Polyfluoropolymers generally have very low surface energy, which allow their surface to remain somewhat free of dirt and debris, as well as shed ice easier compared to materials having a higher surface energy.

Film/fabric composites are also contemplated along with a backing, such as foam, for making the inflatable member or exterior film.

The inflatable members could also be composed of urethane film bladders with a woven or braided cover over the bladder to give it strength and durability. The woven or braided materials may be polyester, pre-stressed polyester, aromatic polyester (trade name VECTRAN® manufactured by Kuraray of Japan), p-phenylene terephtalamide (PpPTA) (trade name TWARON from Akzo), PPTA (poly-paraphenylene terephthalamide) (trade name KEVLAR from DuPont), and polytrimethylene terephthalate (trade name CORTERRA from Shell). The exterior of the woven or braided cover may be coated with various polymers such as cis-polyisoprene, polyurethane, epoxy or polyvinyl chloride. This protects the woven or braided fibers from environmental attack, such as UV or abrasion from sand or other materials that could damage the fibers. Manufacturers include Federal Fabrics-Fibers of Lowell, Mass.; Warwick Mills of New Ipswich, N.H.; Vertigo Inc of Lake Elsinore, Calif.; and ILC Dover of Frederica, Del. The inflatable members may also be partially or completely stiffened through the use of reactive polymer infusion through vacuum assisted resin transfer molding (VARTM) or the curing of previously impregnated polymers such as unsaturated polyesters, epoxy, acrylates or urethanes that are cured through radiation, free radical initiation, or crosslinking with isocyanate.

The inflatable members and skins could also be made from woven or braded textile materials. Exemplary materials include polyesters, polyurethanes, polyamides, polytrimethylene terephthalate, cellulose fibers, rayon, and combinations thereof. Such textiles may be coated to enhance their weatherability and/or durability.

The inflatable construction of the shroud in the wind turbines of the present disclosure allows the turbine to be substantially lighter than conventional turbines. Thus, a less substantial supporting tower may be used.

The skins may be reinforced with a reinforcing material. Examples of reinforcing materials include but are not limited to highly crystalline polyethylene fibers, paramid fibers, and polyaramides.

The interior skin and exterior skin may independently be multi-layer, comprising one, two, three, or more layers. Multi-layer constructions may add strength, water resistance, UV stability, and other functionality. However, multi-layer constructions may also be more expensive and add weight to the overall wind turbine.

The skin may cover all or part of the shroud. For example, the skin may not cover the leading and/or trailing edges of the shroud. The rigid structural members may be comprised of rigid materials. Rigid materials include, but are not limited to, polymers, metals, and mixtures thereof. Other rigid materials such as glass reinforced polymers may also be employed. Rigid surface areas around fluid inlets and outlets may improve the aerodynamic properties of the shrouds. The rigid surface areas may be in the form of panels or other constructions.

While the inflatable members and shroud skins have primarily been described in reference to the ejector shroud, these aspects of the present disclosure may also be included in the turbine shroud.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A wind turbine comprising:
an impeller;
a shroud located concentrically about the impeller;
the shroud comprising:
a first rigid structural member,
a second rigid structural member, and
one or more inflatable members extending between the first rigid structural member and the second rigid structural member.

2. The wind turbine of claim 1, wherein the first rigid structural member comprises an inlet, one or more nozzles located on a trailing side for providing a gas to the one or more inflatable members, and a gas flowpath running from the inlet to the one or more nozzles.

3. The wind turbine of claim 1, wherein the one or more inflatable members each comprise:
a first strut and a second strut, the first and second struts extending from the first rigid structural member and the second rigid structural member; and
a plurality of circumferential spars extending between the first strut and the second strut.

4. The wind turbine of claim 1, wherein the second rigid structural member has a circular crenellated shape.

5. The wind turbine of claim 4, wherein the one or more inflatable members include a set of airfoil inflatable members and a set of surface inflatable members.

6. The wind turbine of claim 1, wherein the one or more inflatable members together have an airfoil shape.

7. The wind turbine of claim 1, wherein the one or more inflatable members are formed from a textile material.

8. The wind turbine of claim 7, wherein the textile material is selected from the group consisting of polyester, polyurethane, polyamide, polytrimethylene terephthalate, cellulose fibers, and mixtures thereof.

9. The wind turbine of claim 1, wherein the shroud further comprises an exterior skin surrounding the one or more inflatable members.

10. The wind turbine of claim 9, wherein the exterior skin comprises a polyurethane or a fluoropolymer.

11. The wind turbine of claim 10, wherein the fluoropolymer is selected from the group consisting of polyvinyl fluoride and polyvinylidene fluoride.

12. The wind turbine of claim 1, wherein the shroud further comprises an interior skin.

13. The wind turbine of claim 12, wherein the interior skin comprises a polyurethane or a fluoropolymer.

14. A wind turbine comprising:
an impeller;
a turbine shroud surrounding the impeller;
the turbine shroud comprising:
a first rigid structural member,
a second rigid structural member having a circular crenellated shape, and
one or more inflatable members extending between the first rigid structural member and the second rigid structural member.

15. The wind turbine of claim 14, wherein the first rigid structural member comprises an inlet, one or more nozzles located on a trailing side for providing a gas to the one or more inflatable members, and a gas flowpath running from the inlet to the one or more nozzles.

16. The wind turbine of claim 14, wherein the one or more inflatable members include a set of airfoil inflatable members and a set of surface inflatable members.

17. The wind turbine of claim 14, wherein the shroud further comprises an exterior skin surrounding the one or more inflatable members.

18. The wind turbine of claim 14, wherein further comprising an ejector shroud, the ejector shroud having an inlet end, the inlet end of the ejector shroud surrounding an outlet end of the turbine shroud.

19. A wind turbine comprising:
an impeller;
a turbine shroud surrounding the impeller and having an outlet end; and
an ejector shroud surrounding the turbine shroud and having an inlet end, the inlet end of the ejector shroud surrounding an outlet end of the turbine shroud.
wherein the ejector shroud comprises:
a first rigid structural member,
a second rigid structural member, and
one or more inflatable members extending between the first rigid structural member and the second structural member.

20. The wind turbine of claim 19, wherein the one or more inflatable members together have an airfoil shape.
